(19) United States
(12) Patent Application Publication
(10) Pub. No.: US 2017/0161809 A1
(43) Pub. Date: Jun. 8, 2017

(54) PROCUREMENT RECOMMENDATION SYSTEM

(71) Applicant: XEEVA, INC., Madison Heights, MI (US)

(72) Inventors: Dilip Dubey, Troy, MI (US); Dineshchandra Harikisan Rathi, San Carlos, CA (US)

(21) Appl. No.: 14/960,412

(22) Filed: Dec. 6, 2015

(51) Int. Cl. G06Q 30/06; G06F 3/0482; G06F 17/30

(52) U.S. Cl. CPC G06Q 30/0613; G06Q 30/0611; G06Q 30/0603; G06F 17/3053; G06F 17/30528; G06F 3/0482; G06F 17/30867; G06F 17/30321

(57) ABSTRACT

A system may include at least one server in communication with a computing device over a communication network. The at least one server may be configured to receive from the computing device identification of at least one desired product or service to procure; generate an RFx for the at least one desired product or service; determine at least one of: at least one recommended buyer to procure the desired at least one product or service, and at least one recommended supplier of the desired at least one product or service; and generate on the graphical user interface of the computing device at least one of a list of the at least one recommended buyer, and a list of the at least one recommended supplier.

### BACKGROUND

In many businesses, procurement of products and/or services may require a lengthy process involving many different parties. A typical procurement involves a requester who orders the items for the business. The requester may find the particular items in a catalog, and then passes along the request to a buyer group. Often, there is no pre-existing relationship between the requester and the buyer group, and as such, the requester has no information as to the reliability of the buyer, and therefore has little control after the request leaves the requester. Then the buyer secures a supplier for the procurement request. Thus, the requester loses another degree of control with the procurement. Further, because of the exchanging of the request between multiple parties, there often tends to be latency in the order being fulfilled.

Therefore, there exists a need for a procurement recommendation system by which a requester can have some level of control throughout the procurement process, including being able to tailor the buyer and the supplier to the requester's particular needs and demands, while also streamlining the process to reduce any latency issues.

### BRIEF DESCRIPTION OF THE DRAWINGS

FIG. 1 is a system diagram of an exemplary procurement recommendation system;

FIG. 2 is a data flow diagram of the exemplary procurement recommendation system of FIG. 1;

FIG. 3 is a flow diagram of an exemplary procurement process;

FIG. 4 is an exemplary screenshot of a configuration screen for customizing the procurement process of FIG. 3;

FIG. 5 is a flow diagram of an exemplary buyer recommendation and selection process;

FIG. 6 is an exemplary screenshot of a provided list of recommended buyers;

FIG. 7 is a flow diagram of an exemplary supplier recommendation and selection process;

FIG. 8 is a table of exemplary parameters and sub-parameters for determining recommended suppliers; and

FIG. 9 is an exemplary screenshot of recommended approval chains.

### DETAILED DESCRIPTION

Generally, procuring items and/or services, for example for an office space or workstation, may involve communication between many different parties, thereby resulting in potential latency with the requests and therefore delay in ultimately procuring the items and/or services. In addition, there may be uncertainty as to which buyers to use to procure the items and/or services and/or which suppliers may be most reliable or may best fit the needs of the particular procurement. To address these and other issues, an exemplary procurement system may include at least one server in communication with a computing device over a communication network. The at least one server may be configured to receive from the computing device identification of at least one desired product or service to procure, and then generate an RFx, which may include, but is not limited to, a request for information (RFI), request for proposal (RFP), or a request for quotation (RFQ) for the at least one desired product or service. The at least one server may also be configured to determine at least one of at least one recommended buyer to procure the desired at least one product or service, and at least one recommended supplier of the desired at least one product or service. The at least one server may further be configured to generate on the graphical user interface of the computing device at least one of a list of the at least one recommended buyer, and a list of the at least one recommended supplier.

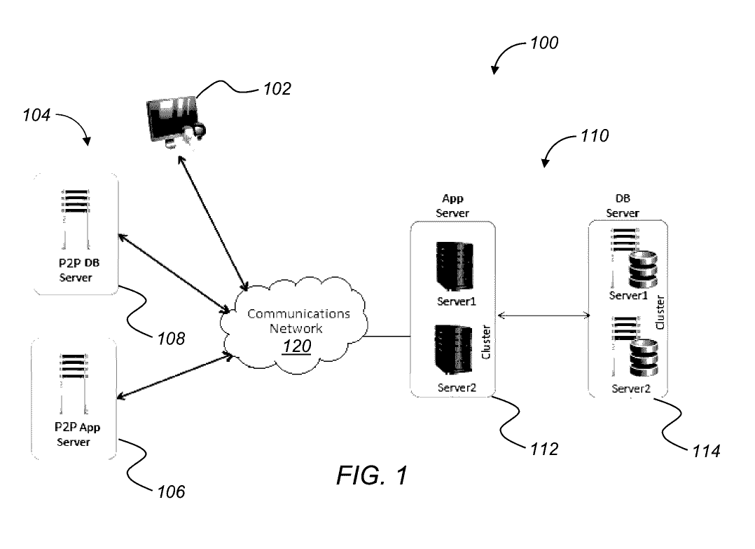

Referring now to the figures, FIG. 1 illustrates an exemplary procurement recommendation system 100 that offers a streamlined procurement process that is suited to the needs and/or preferences of the user requesting procurement. The system 100 may be a subscription-based system in which the user, the buyers performing and/or overseeing the procurement, and the suppliers providing the procurement each have accounts. The system 100 generally may include a computing device 102 by which a user or requester may participate in the procurement process. For clarity purposes with respect to the description of the remainder of the system 100 and operation thereof, the computing device 102 will be referred to hereinafter as the requester 102. The requester 102 generally may include a graphical user interface through which the user may interface with the system 100, and may further access the system through various web browsers installed on the requester 102. The web browsers may include, but are not limited to Microsoft® Internet Explorer™, Opera®, Firefox®, K-Meleon™, Google® Chrome™ and Apple® Safari® web browsers.

The system 100 may also include a procure-to-pay (P2P) engine 104 that may include an application server 106 and a database server 108. While FIG. 1 depicts the application server 106 and the database server 108 as separate servers, it should be appreciated that they may be combined as one server. It should also be appreciated that each server 106 and 108 may also be configured to perform operations of the other server, and further that the P2P engine 104 may include additional servers. The P2P engine 104 generally may interact and exchange data and information with the requester 102, the buyers, and the suppliers over a communications network 120. The communications network 120 may include, but is not limited to any combination of, Ethernet, Bluetooth, Wi-Fi, Wi-Fi protocols (802.11b, 802.11g, 802.11n, etc.), 3G, 4G, or any other wired or wireless communications mechanisms.

The system 100 further may include a primacy engine 110 that may include an application server 112 and a database server 114. While FIG. 1 depicts the application server 112 and the database server 114 as each including two servers, it should be appreciated that the application server 112 and the database server 114 may include any number of servers, including just one, and further that they may be combined as one server. It should also be appreciated that each server 106 and 108 may also be configured to perform operations of the other server. Further, while the application server 112 is shown connected directly to the database server 114, it should be appreciated that they may be in communication with each other over the communications network 120, for example, where the data store 102 is part of a cloud-based database. The primacy engine 110 generally may act as a virtual buyer that analyzes certain criteria, parameters, and other information retrieved or received from the P2P engine 104 and/or the market place (not shown), i.e., where information regarding the suppliers is readily accessible, in recommending and selecting buyers and/or suppliers for the requested procurement. The primacy engine 110 may be in communication with the P2P engine 104 and the market place over the communications networks 120.

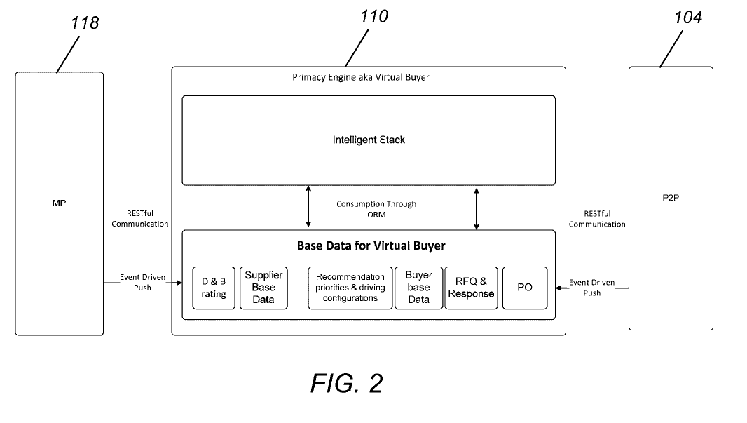

Referring now to FIG. 2, an exemplary data flow between the primacy engine 110 and the P2P engine 104, and between the primacy engine 110 and the market place 118 is shown. In general, the primacy engine 110 may obtain from the market place 118 information relating to the suppliers, including, but not limited to, supplier base data and a Dun & Bradstreet® (D&B) rating. The primacy engine 110 may obtain from the P2P engine 104 past purchase order data, RFx (including, but not limited to request for information (RFI), request for proposal (RFP), or request for quotation (RFQ)) and response information, buyer base data, and recommendation priorities and driving configurations set by the requester 102. As explained in more detail hereinafter, the primacy engine 110, via an intelligent stack, may use the recommendation priorities and driving configurations, the buyer base data, and RFx transactional data to determine a recommended buyer or list of recommended buyers to carry out the procurement request from the requester 102. Similarly, the primacy engine 110 may use the supplier base data and the past purchase order data to determine a recommended supplier or list of recommended suppliers to provide the product(s) and/or service(s) being requested in the procurement request. The primacy engine 110 may further analyze the RFx responses received from suppliers to ultimately recommend and/or select a final supplier.

In general, computing systems and/or devices, such as the requester 102, the application server 106 and database server 108 of the P2P engine 104, and the application server 112 and the database server 114 of the primacy engine 110, may include at least one memory and at least one processor. Moreover, they may employ any of a number of computer operating systems, including, but not limited to, versions and/or varieties of the Microsoft Windows® operating system, the Unix operating system (e.g., the Solaris® operating system distributed by Oracle Corporation of Redwood Shores, Calif.), CentOS, the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Further, the computing Examples of computing devices include, without limitation, a computer workstation, a server, a desktop, a notebook, a laptop, a handheld computer, a smartphone, a tablet, or some other computing system and/or device.

Such computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, Tomcat, representational state transfer (REST), etc. In general, the processor (e.g., a microprocessor) receives instructions, e.g., from the memory, a computer-readable medium, etc., and executes these instructions, thereby performing one or more processes including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instruction) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including, but not limited to, coaxial cables, copper wire, and fiber optics, including the wires that comprise a system bus coupled to a processor of a computer. Common forms of computer-readable media include, for example, a floppy disk, a flexible disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores, such as included with the database servers 106 and 114, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein. Alternatively, the application software product may be provided as hardware or firmware, or combinations of software, hardware, and/or firmware.

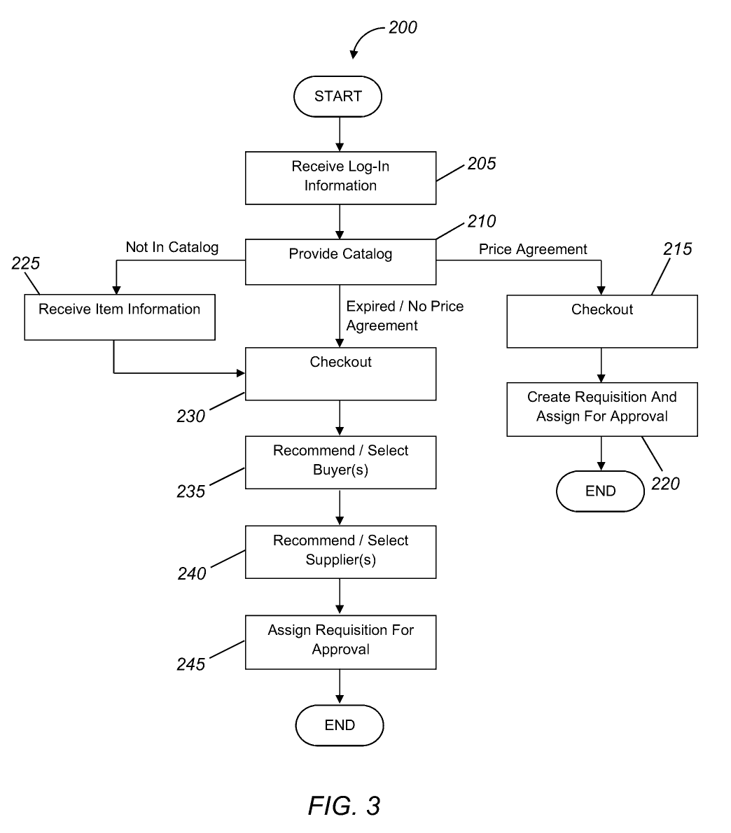

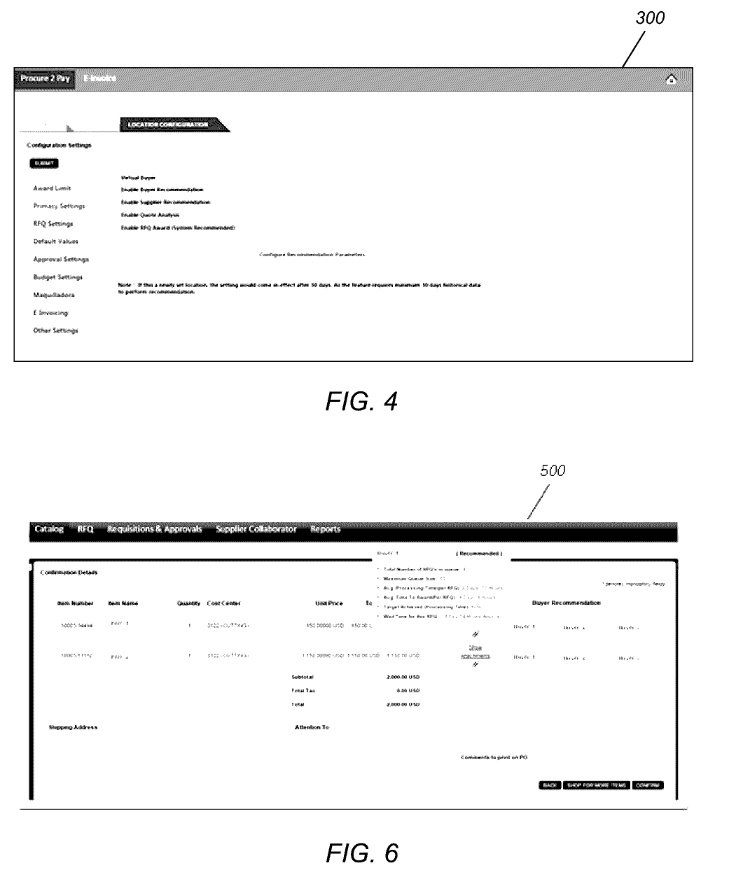

Referring now to FIG. 3, an exemplary procurement process 200 for utilizing the system 100 is illustrated. Process 200 may begin at block 205 in which the P2P engine 104 may prompt the requester 102 for login credentials, and the requester 102 logs in. If the requester 102 does not have an account, the P2P engine 104 may prompt the requester 102 to sign up by providing, for example, personal information, company information, login information, and/or payment information. The requester 102 may also be able to customize the particular services to be associated with the account. After login, the requester 102 may be provided with a configuration screen, as seen in the exemplary screenshot 300 in FIG. 4, where the requester 102 may select different options and/or parameters for the system 100 to perform with respect to the procurement. For example, as seen in FIG. 4, the requester 102 may select to enable buyer recommendation, supplier recommendation, quote analysis, and/or RFQ Award. There may also be a “Virtual Buyer” selection that would automatically enable these features. It should be appreciated that there may be other parameters and/or options that may be available for the requester 102 to select. It should be appreciated that an administrator (not shown) of system 100 may configure any of the options and parameters in addition to or in lieu of the requester 102.

After block 205, process 200 may proceed to block 210 in which the P2P engine 104 may provide a catalog of items, i.e., products and/or services, from which the requester 102 may choose to procure and add to a virtual shopping cart. The selected item(s) may be subject to an active price agreement, an expired price agreement, or not subject to a previous price agreement, or the catalog may not have the desired item(s). For scenarios in which the item(s) may be subject to an active price agreement, process 200 may proceed to block 215 in which the requester 102 may choose to checkout with the selected item(s). Then at block 220, system 100 may create a requisition and submit it for approval, after which process 200 may end. Thus, generally if the item(s) is subject to a price agreement, the primacy engine 110 may play no role, as no buyer or supplier needs to be recommended, as these parties are already set according to the active price agreement. The existence and status of the price agreement generally may be stored in any database, including the P2P database server 108.

For scenarios in which the item(s) may be subject to an expired price agreement or not subject to a price agreement at all, process 200 may proceed to block 230 in which the requester 102 may choose to checkout with the selected item(s). For scenarios in which the desired item(s) are not in the catalog, process 200 may first proceed to block 225 in which the P2P engine 104 may provide the requester 102 with a form or other entry fields, for example, by generating the form on the graphical user interface of the requester 102. The requester 102 may then input information relating to the desired item(s), including but not limited to, name, category, unit price, and the like. The provided information may allow the P2P engine 104 to identify and look up the item(s) in the database server 108 or any other source accessible over the communications network. After block 225, process 200 may proceed to block 230 in which the requester 102 may choose to checkout with the desired item(s). During checkout, the requester 102 may provide additional information, including, but not limited to, shipping address, which may be inputted in an entry field or may be selected from a list of previously established addresses that may be associated with the account of the requester 102, a “Required by” date by which the requester 102 may require the item(s), additional comments and/or instructions that may be provided to a buyer and/or a supplier, and the like. When this is complete, the P2P engine 104 may generate an RFx, and may provide transactional information to the requester 102, such as an RFx number and/or a cart ID.

Buyer Recommendation/Selection

At block 235, a buyer may be determined. The buyer may have different roles in the procurement process depending upon selections received from the requester 102, for example, via the configuration screen in FIG. 4. For example, if the requester 102 opts for the system 100 to only recommend a buyer, the selected buyer may be charged with selecting a supplier. If the requester 102 opts for the system 100 to recommend and/or select the supplier, as discussed in more detail below, the buyer, which may be automatically selected by the system 100, may have more of an overseeing role, stepping in if issues arise with the supplier(s). If the requester 102 opts for the system to recommend both buyers and suppliers, the selected buyer may recommend supplier(s) in addition to the supplier(s) recommended by the system 100.

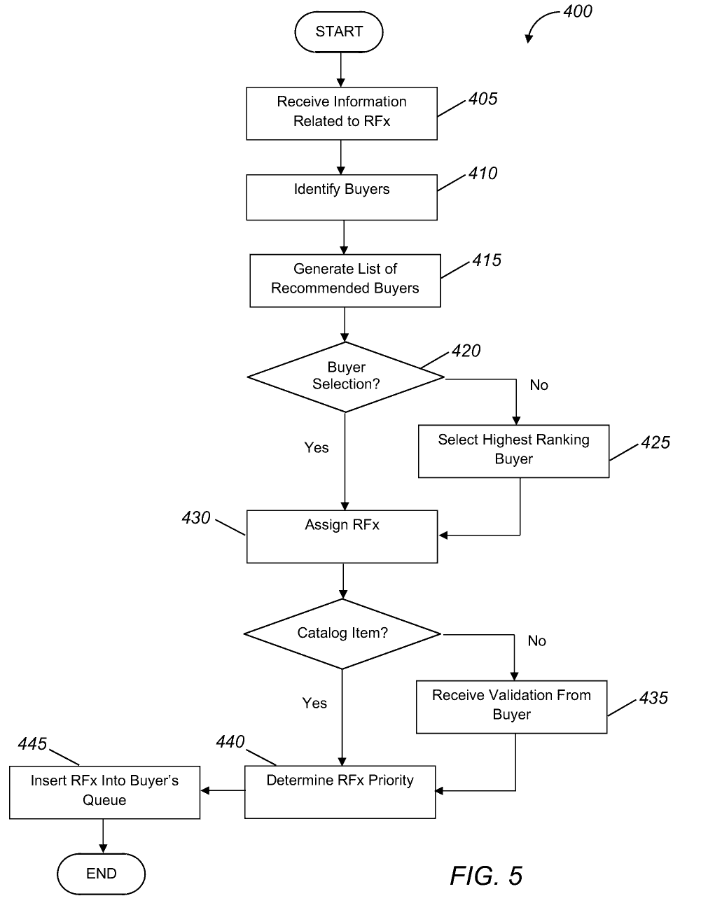

Referring now to FIG. 5, an exemplary process 400 for recommending buyers and selecting a buyer is illustrated. At block 405, the P2P engine 104 may provide to the primacy engine 110 information related to each item in the RFx such that the primacy engine may provide a list of recommended buyer(s). Such information may include, but is not limited to, a final location where the item(s) are to be provided, a category of the item(s), and the like. At block 410, the primacy engine 110 may utilize this information to identify and select any number of recommended buyers that meet certain criteria related to the information received from the P2P engine 104. For example, the primacy engine 110 may identify all buyers that have a certain level of experience with the particular category of the item, e.g., has a number of transactions win the category exceeding a preset threshold, and/or is located within a preset distance radius from the final location of the item(s). Such presets may be set or altered by the requester, for example, at the configuration screen illustrated in FIG. 4. At block 415, the primacy engine 110 may then provide the list of recommended buyers, along with buyer information, to the P2P engine 104. The buyer information may include, but is not limited to, buyer's average process time, buyer's queue length, average wait time for the RFx to get processed, and percentage of RFx's that the buyer has processed on time or before a calculated average process time. The primacy engine 110 may calculate such information based on different algorithms, for example, those used in an M/M/1 queuing theory. The algorithms may utilize historical data of the buyers' past transactions saved in any of the database servers 108 and/or 114. Where there is no historical data for a buyer, the buyer may provide such data to the system 100 when initially subscribing. The P2P engine 104, in turn, may provide the list to the requester 102, for example by generating a list on the graphical user interface of the requester 102, as seen in the exemplary screenshot 500 illustrated in FIG. 6. As seen in FIG. 6, each item may have a list of recommended buyers. The buyer information may be selectively visible on the graphical user interface, for example by hovering over any one of the buyers, or by clicking on one of the buyers. While FIG. 6 illustrates three recommended buyers for each item, it should be appreciated that there may be any number of recommended buyers provided. In addition, the maximum and minimum number of buyers provided may be a configurable setting set by the requester 102, for example at the configuration screen in FIG. 4.

At block 420, the requester 102 may select a buyer from the list of recommended buyers for each item. If the requester 102 does not select a buyer, process 400 may proceed to block 425 in which the P2P engine 104 or the primacy engine 110 may select the highest ranking buyer. The ranking may be determined based on the buyer information, for example, a weighing of the different factors, the importance of which may be set by the requester 102. At block 430, the RFx may then be assigned to the selected buyer. Where different items, for example, Item_1 and Item_2 in FIG. 5, are assigned to multiple buyers, the P2P engine 104 and/or the primacy engine 110 may split the RFx into multiple RFx's, one for each buyer. If the item(s) to be procured were selected from the catalog, the P2P engine 104 may assign the RFx to the selected buyer. If the item(s) were not from a catalog but rather were entered via a form or entry fields, process 400 may proceed to block 435 in which the P2P engine 104 may require the selected buyer to first validate the RFx.

At block 440, prior to the RFx being inserted into the buyer's queue, the primacy engine 110 may assign a priority index to the RFx based on different parameters, including, but not limited to, the total value of the RFx, the type of request, e.g., service or material, a category of the item(s), the requesters, and the due date. Thus, when the RFx is inserted into the buyer's queue, it may be prioritized with other RFx's in the queue. Any one of these parameters may be set in the system 100 as a default for sorting the RFx's in the buyer's queue, and the default may be changed by the requester 102. In addition or alternatively, a primacy index of the RFx may be calculated, for example using a weighted arithmetic mean method. The primacy index may then be compared with the primacy indices of other RFx's in the queue, and inserted into the queue according to its priority at block 445. Process 400 may end thereafter.

Supplier Recommendation/Selection

Referring back to FIG. 3 at block 240, a supplier may be determined. As illustrated in FIG. 2, the primacy engine 110 may obtain supplier base data from the market place 118. In general, the suppliers may be divided into existing suppliers that are subscribed and have a history of prior transactions, and new suppliers. For existing suppliers, the supplier base data may include information for each supplier related to a number of different parameters and sub-parameters. This information may be constantly or periodically updated with each new order in which the supplier has been involved. The parameters may include, but are not limited to, quality of the supplier, performance of the supplier, cost of using the supplier, responsiveness of the supplier, risk of using the supplier, and an internal review of the supplier.

Quality of the supplier may be based on such sub-parameters as subscription status, amount achieved in the previous quarter, and number of returns due to bad quality. Performance of the supplier may be based on such sub-parameters as on-time delivery, late delivery, and actual versus quoted lead time. The primacy engine 110 may determine whether past deliveries were on-time or late by obtaining purchase order information from the P2P database server 108, and comparing a delivery due date and an actual receipt date. The cost of using the supplier may be based on such sub-parameters as payment terms, payment methods, freight terms, and total cost variation. The primacy engine 110 may again obtain purchase order information from the P2P database server 108 and calculate the number of times the supplier maintained default payment terms and/or freight terms. The responsiveness of the supplier may be based on such sub-parameters as number of emergency quotes, order processing, and compliance to payment terms. With respect to emergency quotes, the primacy engine 110 may obtain RFx response data and may calculate the response time by the supplier. With respect to order processing, the primacy engine 110 may obtain purchase order information, and may calculate the average time taken by the supplier to process an order. With respect to compliance with payment terms, the primacy engine 110 may obtain purchase order information, and may calculate the number of purchase orders with exception payment terms for emergency orders. The risk of using the suppliers may be based on such sub-parameters as supplier location, product availability, non-conformance incidents, and a Dun & Bradstreet rating for that supplier. The primacy engine 110 may obtain this information from the market place 118. Internal review may be based on such sub-parameters as a supplier survey and a cost of poor quality. The supplier review may be based on feedback, such as a rating, provided by the requesters 102 and buyers once the transaction is completed. It should be appreciated that there may be any number of parameters and sub-parameters.

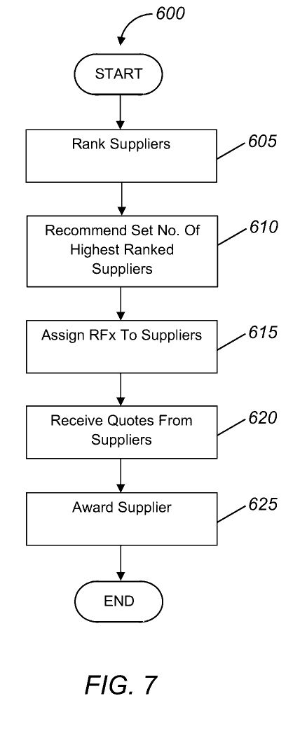

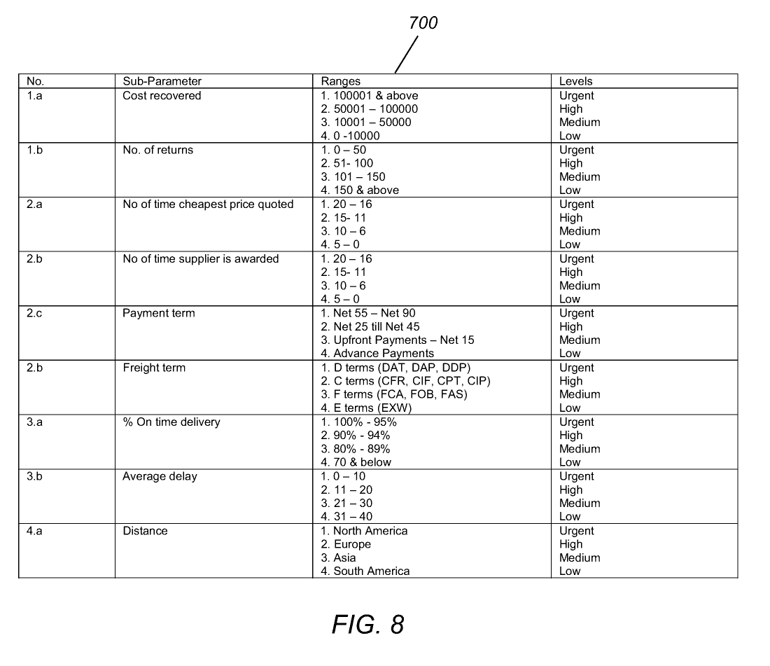

Referring now to FIG. 7, an exemplary process 600 for recommending and selecting supplier(s). At block 605, the primacy engine 110 may rank the suppliers based on the parameters and sub-parameters. Each parameter and sub-parameter may have an equal weight in terms of priority by default. However, the requester 102 may select a subset of the parameters, and for each selected parameter, a subset of the sub-parameters. The requester 102 may then rank the priority of the selected parameters and sub-parameters, thereby providing different weights. For each sub-category, a range of values may be determined, and for each range, a level of importance. FIG. 8 illustrates an exemplary table 700 of selected sub-parameters and associated ranges and levels. While FIG. 8 only shows four ranges and levels for each sub-parameter, it should be appreciated that there may be any number of ranges and levels, and further that not all of the sub-parameters may have the same number of ranges and levels. The ranges provided in table 700 are exemplary only and are configurable by the requester 102.

For each supplier, based on the supplier base data obtained from the market place 118, the primacy engine 110 may determine within which range, and therefore which level, the supplier falls. Using a weighted arithmetic mean method based on the priorities established by the requester 102, the primacy engine 110 may then calculate a primacy index number for each supplier. The primacy engine 110 may then rank the suppliers based on their primacy index numbers.

New suppliers generally may provide information to create a scorecard. The information may include, but is not limited to, the following categories: (1) payment terms; (2) freight terms; (3) category (filter criteria); (4) favorite supplier (filter criteria); (5) location of supplier (distance from source); (6) payment methods; (7) willingness to use the system; (8) online supplier survey; (9) DB rating. The requester 102 may similarly select and/or apply a rank of the different categories. Each category may have a range and a level of importance. The primacy engine 110 may calculate a primacy index number for each supplier, also using a weighted arithmetic mean method based on the priorities established by the requester 102, and then rank the new suppliers based on the their primacy index numbers.

At block 610, the primacy engine 110 may recommend a set number of existing suppliers with the highest primacy index numbers and/or a set number of new suppliers with the highest primacy index numbers. The number of recommended existing and new suppliers may be configurable by the requester 102. A list of the recommended existing and/or new suppliers may be generated on the graphic user display of the requester 102. At block 615, the P2P engine 104 may then assign the RFx to the recommended suppliers, including a date by which a quote is due.

At block 620, the P2P engine 104 may receive quotes from the suppliers. If the quotes are not received by the quote due date, the P2P engine 104 may be configured to extend the due date by a set number of days configurable by the requester 102, and may also add a set number of the next suppliers in the rankings that were not previously recommended. The P2P engine 104 may then provide the quotes to the primacy engine 110 to be evaluated. At block 625, the primacy engine 110 may select a quote to whom to award the requisition for the item(s). In doing so, the primacy engine 110 may evaluate such parameters as price and/or lead time. The parameters may be configurable by the requester 102. For each parameter, the primacy engine 110 may be configured to determine if the variance between the minimum quoted value and the maximum quoted value is within a configurable variance. For example, if the price variance between the lowest quoted price and the highest quoted price is less than 10%, then the primacy engine 110 may be configured to assign the RFx back to the buyer to negotiate further on the RFx with the suppliers. If the variance is 10% or above, the primacy engine 110 may award the requisition to the best quote, e.g., lowest price. Process 600 may end thereafter.

Approval Chain

Referring back to FIG. 3, after the award to the supplier, process 200 may proceed to block 245 at which the requisition may be assigned for approval. Generally, before the transaction may be completed, the requisition must be approved by some chain or hierarchy of approvers. System 100 may have data associated with specific approvers related to the buyer, the category of the procured item(s), the location, and the like. The data may include such statistics as approval rate, wait time for approval, and the like.

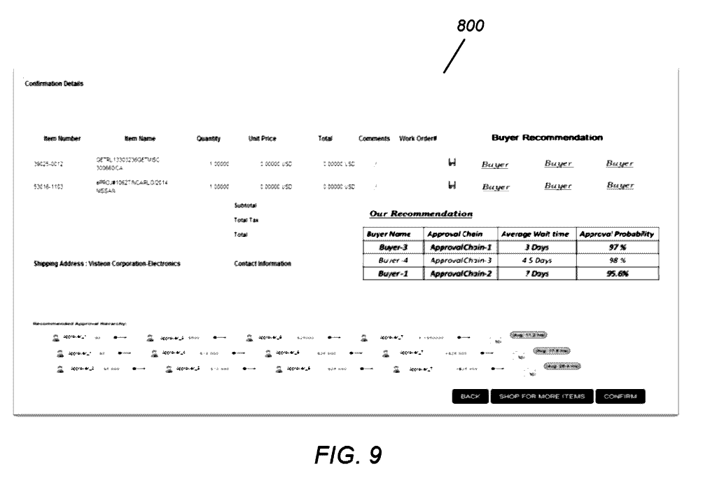

The primacy engine 110 may obtain the approver data based on the selected buyer and/or the category of the procured item(s), and may provide a recommended approval chain along with such information as the average wait time and the approval probability, as seen in the exemplary screenshot 800 in FIG. 9. While FIG. 9 illustrates four approvers in the approval chain, it should be appreciated that there may be any number of approvers, depending upon the needs and procedures of the particular requester 102, and may be configured by the requester 102. The requester 102 may then select the preferred approval chain. If the requester 102 does not select any approval chain, primacy engine 110 may select a default approval chain, for example, one with the highest approval probability or one with the shortest wait time. Once the approval chain is selected, the primacy engine may prioritize the requisition in each of the approver's queue by assigning a priority index to the requisition. The priority index may be based on total value of the requisition, type of request, e.g., service or material, category of the item(s), and requesters. The primacy engine 110 may evaluate the priority index of the particular requisition and compare it with existing requisitions in the approver's queue, and then prioritize the requisition, for example using a sorted linked list concept. It should be appreciated that any method, algorithm, process, or the like may be utilized to sort the requisitions.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system comprising:
at least one server in communication with a computing device over a communications network, the at least one server being configured to:
generate on a graphical user interface of the computing device a plurality of selectable options of information to be determined and outputted by the at least one server;
receive from the computing device at least one selection from the plurality of selectable options;
provide to the computing device a catalog of a plurality of products and services from which at least one desired product or service to procure is selectable;
receive from the computing device identification of the at least one desired product or service by one of:
if the at least one desired product or service is not available in the catalog, generating on the graphical user interface of the computing device at least one entry field in which the at least one desired product or service is entered, and at least one other entry field in which a unit price for the at least one desired product or service is entered; or
if the at least one desired product or service is in the catalog, receiving a selection of the at least one desired product or service;
generate an RFx for the at least one desired product or service;
based on the at least one selection from the plurality of selectable options, determine at least one of:
at least one recommended buyer to procure the desired at least one product or service, and
at least one recommended supplier of the desired at least one product or service;
generate on the graphical user interface of the computing device at least one of a list of the at least one recommended buyer, and a list of the at least one recommended supplier.

2. (canceled)

3. The system of claim 1, wherein determining the at least one recommended buyer includes:
determining at least one of a category of the at least one desired product or service, and an intended location for the at least one desired product or service;
determining, from a database of a plurality of buyers, a list of applicable buyers that match the at least one of a category and an intended location; and
comparing performance rankings of the applicable buyers.

4. The system of claim 3, wherein the at least one server is further configured to:
receive from the computing device a selection of one of the at least one recommended buyer;
if no selection is received from the computing device, select the one of the at least one recommended buyer with the highest performance ranking; and
assigning the generated RFx to the selected buyer.

5. The system of claim 4, wherein the at least one server is further configured to:
calculate a primacy index for the generated RFx;
compare the primacy index of the generated RFx with primacy indices of RFx's in a queue of the selected buyer; and
sort the RFx's and the generated RFx in the queue according to the respective primacy indices.

6. The system of claim 1, wherein determining the at least one recommended supplier includes:
receiving, from the computing device, a selection of at least a subset of a plurality of parameters, and a rank of the selected parameters;
receiving, from the computing device, a rank of sub-parameters for each of the selected parameters;
calculating a priority index number of each of the suppliers based on the ranks of the selected parameters and sub-parameters and a supplier score for each of the sub-parameters; and
comparing the priority index numbers of the suppliers. (Original) The system of claim 1, wherein the at least one server is further configured to:
assign the RFx to the at least one recommended supplier;
receive a quote from each of the at least one recommended supplier;
compare all the received quotes; and
select the supplier from the at least one recommended supplier with the lowest quote.

8. A process comprising:
generating on a graphical user interface of a computing device a plurality of selectable options of information to be determined and outputted by the at least one server;
receiving from the computing device at least one selection from the plurality of selectable options;
generating on the graphical user interface of the computing device a catalog of a plurality of products and services from which at least one desired product or service to procure is selectable;
receiving from the computing device identification of the at least one desired product or service by one of:
if the at least one desired product or service is not available in the catalog, generating on a graphical user interface of the computing device at least one entry field in which the at least one desired product or service is entered, and at least one other entry field in which a unit price for the at least one desired product or service is entered; or
if the at least one desired product or service is in the catalog, receiving a selection of the at least one desired product or service;
generating an RFx for the at least one desired product or service;
based on the at least one selection from the plurality of selectable options, determining at least one of:
at least one recommended buyer to procure the desired at least one product or service, and
at least one recommended supplier of the desired at least one product or service; and
generating on a graphical user interface of the computing device at least one of a list of the at least one recommended buyer, and a list of the at least one recommended supplier.

9. (canceled)

10. The process of claim 8, wherein determining the at least one recommended buyer includes:
determining at least one of a category of the at least one desired product or service, and an intended location for the at least one desired product or service;
determining, from a database of a plurality of buyers, a list of applicable buyers that match the at least one of a category and an intended location; and
comparing performance rankings of the applicable buyers.

11. The process of claim 10, further comprising:
receiving from the computing device a selection of one of the at least one recommended buyer;
if no selection is received from the computing device, selecting the one of the at least one recommended buyer with the highest performance ranking; and
assigning the generated RFQ to the selected buyer.

12. The process of claim 11, further comprising:
calculating a primacy index for the generated RFx;
comparing the primacy index of the generated RFx with primacy indices of RFx's in a queue of the selected buyer; and
sorting the RFx's and the generated RFx in the queue according to the respective primacy indices.

13. The process of claim 8, wherein determining the at least one recommended supplier includes:
receiving, from the computing device, a selection of at least a subset of a plurality of parameters, and a rank of the selected parameters;
receiving, from the computing device, a rank of sub-parameters for each of the selected parameters;
calculating a priority index number of each of the suppliers based on the ranks of the selected parameters and sub-parameters and a supplier score for each of the sub-parameters; and
comparing the priority index numbers of the suppliers.

14. The process of claim 8, further comprising:
assigning the RFx to the at least one recommended supplier;
receiving a quote from each of the at least one recommended supplier;
comparing all the received quotes; and
selecting the supplier from the at least one recommended supplier with the lowest quote.

15. A system comprising:
a P2P engine having at least one server; and
a primacy engine having at least one server in communication with the at least one server of the P2P engine;
wherein the P2P engine is configured to:
generate on a graphical user interface of a computing device a plurality of selectable options of information to be determined and outputted by the primacy engine;
receive from the computing device at least one selection of the plurality of selectable options;
provide to the computing device a catalog of a plurality of products and services from which at least one desired product or service to procure is selectable;
receive from the computing device over a communications network identification of the at least one desired product or service by one of:
if the at least one desired product or service is not available in the catalog, generating on the graphical user interface of the computing device at least one entry field in which the at least one desired product or service is entered, and at least one other entry field in which a unit price for the at least one desired product or service is entered; or
if the at least one desired product or service is in the catalog, receiving a selection of the at least one desired product or service;
provide to the primacy engine at least one of a location and a category related to the at least one desired product or service;
generate an RFx for the at least one desired product or service; and
generate on the graphical user interface of the computing device at least one of a list of at least one recommended buyer, and a list of at least one recommended supplier wherein the primacy engine is configured to:
based on the at least one selection from the plurality of selectable options, determine at least one of:
at least one recommended buyer to procure the desired at least one product or service; and
at least one recommended supplier of the desired at least one product or service.

16. (canceled)

17. The system of claim 15, wherein determining the at least one recommended buyer includes:
determining at least one of a category of the at least one desired product or service, and an intended location for the at least one desired product or service;
determining, from a database of a plurality of buyers, a list of applicable buyers that match the at least one of a category and an intended location; and
comparing performance rankings of the applicable buyers.

18. The system of claim 17, wherein the P2P engine is further configured to receive from the computing device a selection of one of the at least one recommended buyer; and if no selection is received from the computing device, the primacy engine is further configured to select the one of the at least one recommended buyer with the highest performance ranking; and the P2P engine is further configured to assign the generated RFx to the selected buyer.

19. The system of claim 18, wherein the primacy engine is further configured to:
calculate a primacy index for the generated RFx;
compare the primacy index of the generated RFx with primacy indices of RFx's in a queue of the selected buyer; and
sort the RFx's and the generated RFx in the queue according to the respective primacy indices.

20. The system of claim 15, wherein determining the at least one recommended supplier includes:
receiving, by the P2P engine from the computing device, a selection of at least a subset of a plurality of parameters, and a rank of the selected parameters;
receiving, by the P2P engine from the computing device, a rank of sub-parameters for each of the selected parameters;
calculating, by the primacy engine, a priority index number of each of the suppliers based on the ranks of the selected parameters and sub-parameters and a supplier score for each of the sub-parameters; and
comparing, by the primacy engine, the priority index numbers of the suppliers.

21. The system of claim 4, wherein the performance rank for each of the buyers is based on at least one of average process time of the buyer, queue length of the buyer, average wait time for a RFx to get processed, and percentage of RFx's that the buyer has processed on time or before a calculated average process time.
